(19) United States
(12) Patent Application Publication
(10) Pub. No.: US 2010/0228922 A1
(43) Pub. Date: Sep. 9, 2010

(54) METHOD AND SYSTEM TO PERFORM BACKGROUND EVICTIONS OF CACHE MEMORY LINES

(76) Inventor: Deepak Limaye, Austin, TX (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/400,671

(22) Filed: Mar. 9, 2009

(51) Int. Cl. G06F 12/08; G06F 12/00

(52) U.S. Cl. 711/135; 713/600; 711/122; 711/E12.001; 711/E12.022

(57) ABSTRACT

A method and system to provide a method and system to perform background evictions of cache memory lines. In one embodiment of the invention, when a processor of a system determines that the occupancy rate of its bus interface is between a low and a high threshold, the processor performs evictions of cache memory lines that are dirty. In another embodiment of the invention, the processor performs evictions of the dirty cache memory lines when a timer between each periodic clock interrupt of an operating system has expired. By performing background evictions of dirty cache memory lines, the number of dirty cache memory lines required to be evicted before the processor changes its state from a high power state to a low power state is reduced.

### FIELD OF THE INVENTION

This invention relates to a cache memory, and more specifically but not exclusively, to perform background evictions of cache memory lines in a system.

### BACKGROUND DESCRIPTION

The power consumption and response time are two important aspects of the design of a processor. The processor can be designed to have different power consumption levels to allow for different usage scenarios of a system utilizing the processor. FIG. 1 illustrates a prior art diagram of the various power consumption levels (power states) of a processor at which the processor can operate. When a system is powered by a battery, for example, the system can lower its power consumption level by changing the power state of the processor from a high power state 110 to a medium power state 130. In another example, when the system is inactive for a certain amount of time, the system can lower its power consumption level by changing the power state of the processor from a high power state 110 to a low power state 120.

The system is able to lower its power consumption level further if the entry-exit loop latency of the processor from the high power state 110 to the low power state 120 or to the medium power state 130 is shortened. A processor that requires a long latency to enter into and exit from a low power state spends less time in the low power state and therefore reduces the amount of power consumption that can be saved.

### BRIEF DESCRIPTION OF THE DRAWINGS

The features and advantages of embodiments of the invention will become apparent from the following detailed description of the subject matter in which:

FIG. 1 illustrates a prior art diagram of the various power states of a processor at which the processor can operate;

FIG. 2 illustrates a front side bus system to implement the methods disclosed herein according with one embodiment of the invention;

FIG. 3 illustrates a system to implement the methods disclosed herein according with one embodiment of the invention;

FIG. 4 illustrates a block diagram of a processor in accordance with one embodiment of the invention;

FIG. 5 illustrates a block diagram of a processor in accordance with one embodiment of the invention;

FIG. 6 illustrates a flow chart of the steps to perform background eviction of cache memory lines in accordance with one embodiment of the invention;

FIG. 7 illustrates a flow chart of the steps to perform background eviction of cache memory lines in accordance with one embodiment of the invention; and

FIG. 8 illustrates a cache memory in accordance with one embodiment of the invention.

### DETAILED DESCRIPTION

Reference in the specification to “one embodiment” or “an embodiment” of the invention means that a particular feature, structure or characteristic described in connection with the embodiment is included in at least one embodiment of the invention. Thus, the appearances of the phrase “in one embodiment” appearing in various places throughout the specification are not necessarily all referring to the same embodiment.

Embodiments of the invention provide a method and system to perform background evictions of cache memory lines. In one embodiment of the invention, when a processor of a system determines that the occupancy rate of its bus interface is between a low and a high threshold, the processor performs evictions of cache memory lines that are dirty. A particular line in a cache memory is termed as dirty or modified when the contents of the particular line has been modified and the contents are not synchronized or matched with the contents of a corresponding memory address(es) in a main memory or a higher level cache memory.

In one embodiment of the invention, the processor switches to a low power state by turning off or disabling the cache memory or memories of the processor. In other embodiments of the invention, the processor switches to a low power state by turning off a portion of the cache memory or memories of the processor. For example, some ways of an N-way set associative cache memory can be turned off by the processor. Before a cache memory or parts of a cache memory can be turned off, all modified cache memory lines are evicted by the processor to ensure data integrity. By performing background evictions of dirty cache memory lines to a main memory or to a higher level cache memory that is outside the relevant power domain of a processor's power state, the number of modified cache memory lines required to be evicted before the processor can change its state from a high power state to a low power state is reduced. This allows a system utilizing the processor to reduce its power consumption as the processor is able to extend its time period in a low power state by the time saved in entering the low power state as there is a lesser number of modified cache memory lines required to be evicted.

For example, in one embodiment of the invention, a processor supports power states compliant with the advanced configuration and power interface specification (ACPI standard, “Advanced Configuration and Power Interface Specification”, Revision 3.0b, published 10 Oct. 2006). For the processor to enter power state C6, the cache memory(s) in the processor is/are powered down to conserve power consumption. Before the processor is allowed to transition into the power state C6 from an active power state C0, any cache memory line with contents that has not been written to main memory, i.e., the contents have modified or dirty data, are to be evicted to the main memory. When background evictions of the modified cache memory lines are performed, it reduces the number of modified cache memory lines. Therefore, the processor requires a short time or latency to enter the low power processor state as there is lesser number of modified cache memory lines to be evicted.

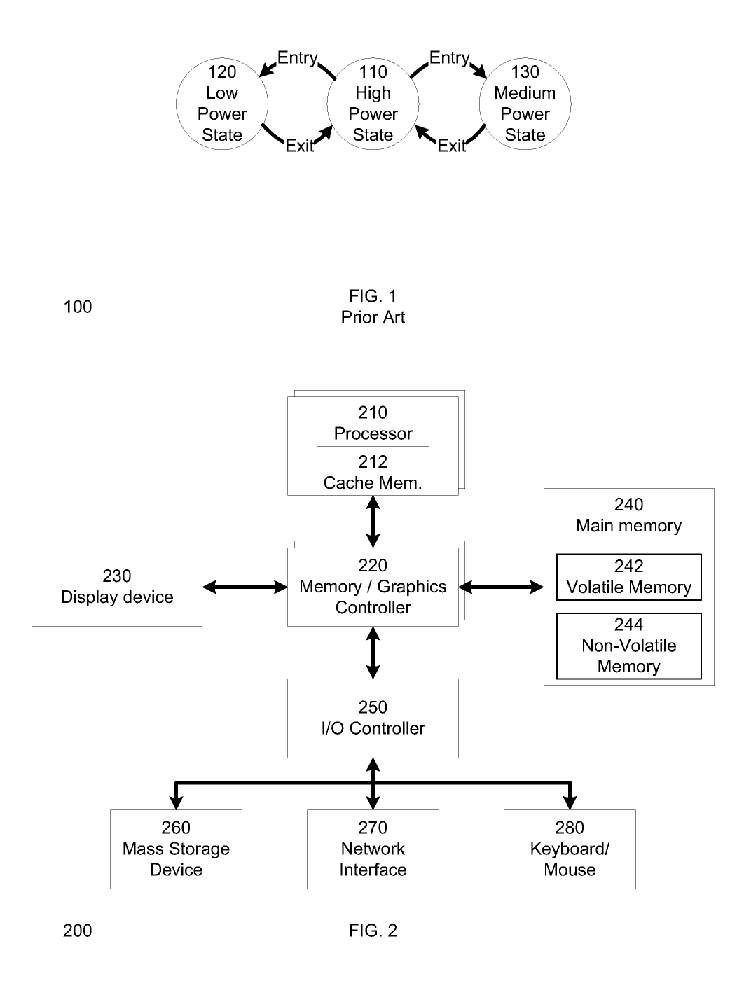

FIG. 2 illustrates a front side bus (FSB) system 200 to implement the methods disclosed herein according with one embodiment of the invention. The system 200 includes but is not limited to, a desktop computer, a laptop computer, a notebook computer, a personal digital assistant (PDA), a server, a workstation, a cellular telephone, a mobile computing device, an Internet appliance or any other type of computing device. In another embodiment, the system 200 used to implement the methods disclosed herein may be a system on a chip (SOC) system.

The system 200 includes a memory/graphics controller(s) 220 and an input/output (I/O) controller 250. The memory/graphics controller(s) 220 typically provides memory and I/O management functions, as well as a plurality of general purpose and/or special purpose registers, timers, etc. that are accessible or used by the processor 210. The processor 210 may be implemented using one or more processors or implemented using multi-core processors. The processor 210 has a cache memory 212 that has at least one embodiment of the invention. The cache memory 212 includes, but is not limited to, level 1, level 2 and level 3, cache memory or any other configuration of the cache memory within the processor 210.

The memory/graphics controller(s) 220 performs functions that enable the processor 210 to access and communicate with a main memory 240 that includes a volatile memory 242 and/or a non-volatile memory 244. The volatile memory 242 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 244 includes, but is not limited by, flash memory, ROM, EEPROM, and/or any other desired type of memory device. The main memory 240 stores information and instructions to be executed by the processor(s) 210. The main memory 240 may also stores temporary variables or other intermediate information while the processor 210 is executing instructions.

The memory/graphics controller(s) 220 is connected to a display device 230 that includes, but is not limited to, light emitting displays (LEDs), liquid crystal displays (LCDs), cathode ray tube (CRT) displays, or any other form of visual display device. The I/O controller 250 is coupled with, but is not limited to, a mass storage device 260, a network interface 270 and a keyboard/mouse 280. In particular, the I/O controller 250 performs functions that enable the processor 825 to communicate with the mass storage device 260, the network interface 270 and the keyboard/mouse 280.

The mass storage device 260 includes, but is not limited to, a solid state drive, a hard disk drive, an universal serial bus flash memory drive, or any other form of computer data storage medium. The network interface 270 is implemented using any type of well known network interface standard including, but is not limited to, an Ethernet interface, a universal serial bus (USB), a third generation input/output interface (3GIO) interface, a wireless interface and/or any other suitable type of interface. The wireless interface operates in accordance with, but is not limited to, the Institute of Electrical and Electronics Engineers (IEEE) wireless standard family 802.11, Home Plug AV (HPAV), Ultra Wide Band (UWB), Bluetooth, WiMax, or any form of wireless communication protocol.

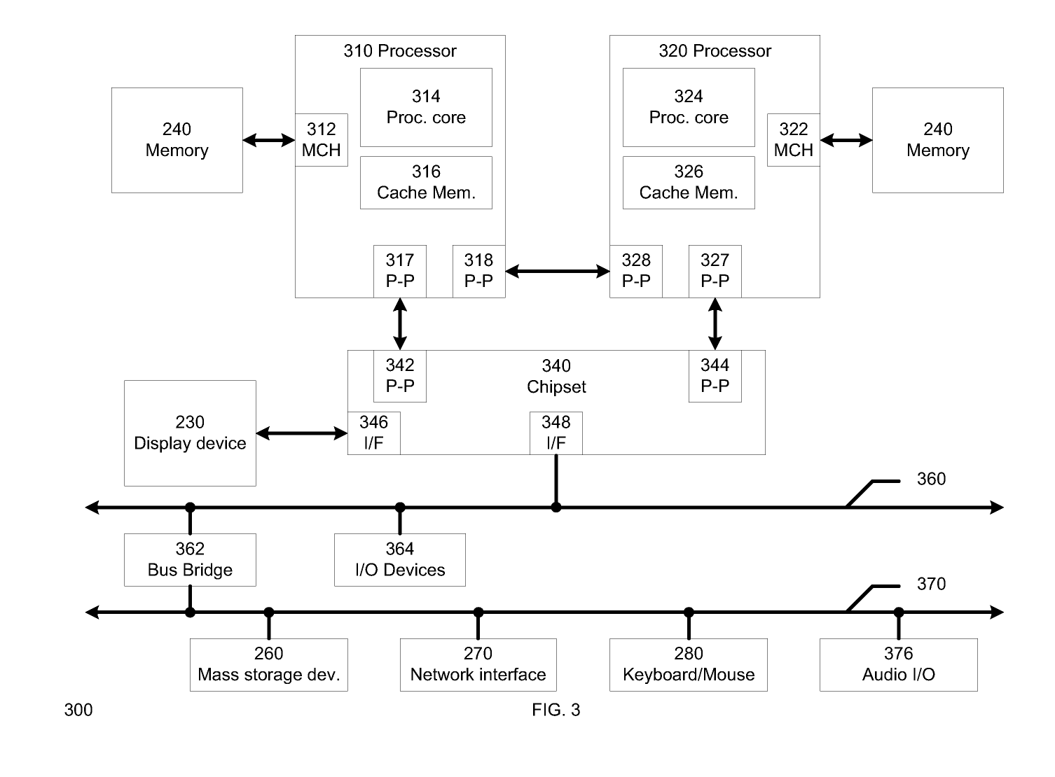

FIG. 3 illustrates a system 300 to implement the methods disclosed herein according with one embodiment of the invention. The processors 310 and 320 are connected to each other via interfaces 318 and 328. In one embodiment of the invention, the interfaces 318 and 328 operate in accordance with a point to point (PtP) communication protocol such as the Intel® QuickPath Interconnect (QPI) or any other communication protocol. The processors 310 and 320 have a cache memory 316 and 326 respectively that has at least one embodiment of the invention. The processors 310 and 320 also have a processor core 314 and 324 respectively for executing instructions of the system 300. The memory controller hubs (MCH) 312 and 322 connect the memory 240 to the processors 310 and 320.

The chipset 340 connects with the processors 310 and 320 via PtP interfaces 317, 342, 327 and 344. The chipset 340 enables the processors 310 and 320 to connect to other modules in the system 300. The chipset 340 connects to one or more buses 360 and 370 that interconnect the various modules 364, 260, 270, 280, and 376. Bus 360 and 370 may be interconnected together via a bus bridge 362 if there is a mismatch in bus speed or communication protocol. While the components shown in FIGS. 2 and 3 are depicted as separate blocks within the systems 200 and 300, the functions performed by some of these blocks may be integrated within a single semiconductor circuit or may be implemented using two or more separate integrated circuits. For example, although the cache memories 316 and 326 are depicted as separate blocks within the processors 310 and 320, the cache memories 316 and 326 can be incorporated into the processor cores 314 and 324 respectively. In addition, there are other functional blocks or more instances of each block that can be connected in systems 200 and 300 that are not shown.

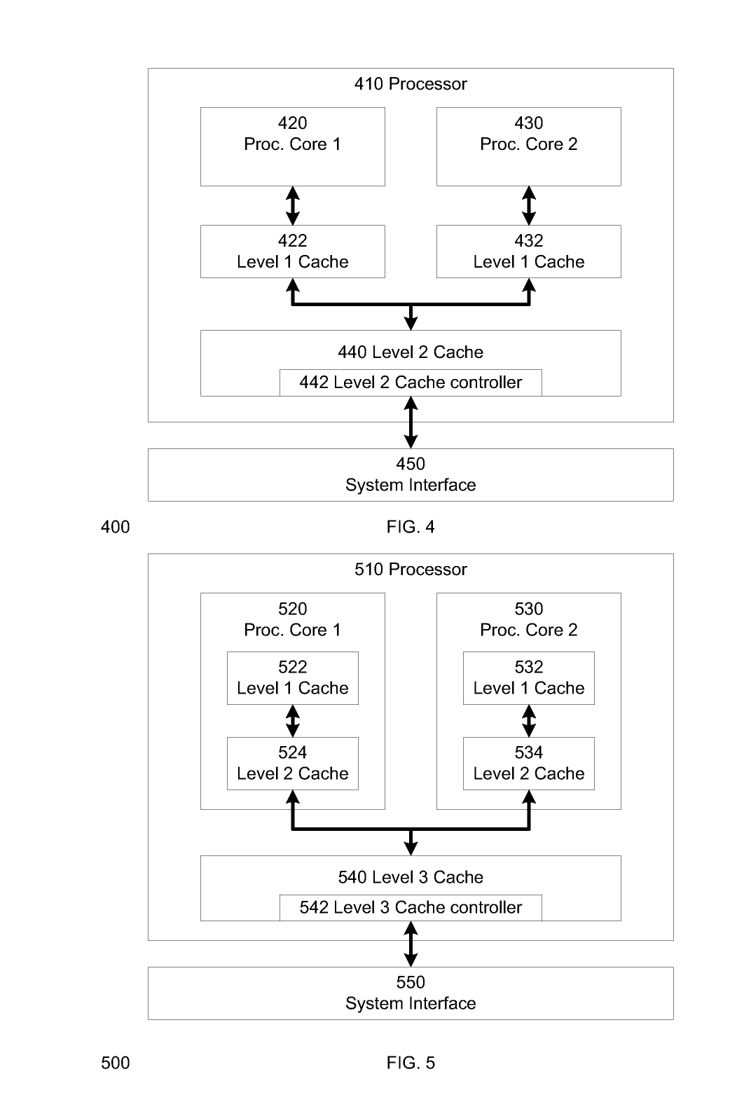

FIG. 4 illustrates a block diagram 400 of a processor 410 in accordance with one embodiment of the invention. The processor 410 has two processor cores 420 and 430 that are connected to a level 1 cache memory 422 and 432 respectively. The level 1 (L1) cache memories 422 and 432 are connected to a level 2 (L2) cache memory 440 and L2 cache memory controller 442. The processor 410 is connected to a system interface 450 via the L2 cache memory controller 442. The system interface 450 includes, but is not limited to, a PtP interface, a fast bus interface, a MCH interface or any other bus interface that can be used to connect the processor 410 to other modules. The processor cores 420 and 430 access contents of a memory address in the main memory 240 via the L1 or L2 cache memories 422 and 432 if there is a cache memory hit.

In one embodiment of the invention, the L2 cache memory controller 442 is a separate module from the L2 cache memory 440 and it couples with the L2 cache memory 440 and the system interface 450. The L2 cache memory controller 440 evicts one or more modified cache memory lines of the L2 cache memory 440 when the utilization rate of the system interface 450 is between a low and a high threshold. The utilization rate of the system interface 450 is a measure of the incoming and outgoing bus traffic of the system interface 450 and it includes, but is not limited to, the bus occupancy rate, the number of bus contention events, the number of bus queues, or any other measure(s) of the bus activity on the system interface 450.

In one embodiment, the high threshold of the utilization rate of the system interface 450 is set at a level such that the cache evictions of the L2 cache memory lines has minimal performance cost to the system. For example, when the utilization rate of the system interface 450 is at 95% of its full utilization rate and performing cache evictions of the L2 cache memory requires less than 5% of its full utilization rate, allowing cache evictions of the L2 cache memory does not degrade the performance of the system as there is available bandwidth on the system interface 450. In one embodiment of the invention, the high threshold rate is set at a level where the utilization rate of the system interface 450 does not exceed its full utilization rate when performing cache evictions of the modified L2 cache memory lines. For example, if performing cache evictions of the L2 cache memory lines requires 3% of the full utilization rate, the high threshold of the utilization rate is set at 97% of the utilization rate of the system interface 405.

Similarly, the low threshold of the utilization rate is also set at a level such that the cache evictions of the L2 cache memory lines has minimal performance cost to the system in one embodiment of the invention. The low threshold of the utilization rate of the system interface 450 determines a scenario where the processor 410 is able to access most of the contents of the memory addresses that it requires within the L1 or L2 cache memories. In such a scenario, the utilization rate of the system interface 450 is low as the processor 410 has little cache memory misses and does not require to utilize the system interface 450 to retrieve the contents of the memory addresses from main memory 240.

If cache evictions of the L2 cache memory lines are enabled when the utilization rate of the system interface 450 is low, the system performance can be degraded. For example, if there are cache memory lines in the L1 cache memories 422 and 432 that are repeatedly evicted to the L2 cache memory 440, allowing these cache memory lines in the L2 cache memory 440 to evict to the main memory 240 via the system interface 450 has limited usefulness as these cache memory lines in the L2 cache memory 440 is modified again in later cycles. The bus request to evict these modified cache memory lines of the L2 cache memory 440 is a waste of power and can cause a performance loss if the L2 eviction request is scheduled before an actual request of the system. In one embodiment of the invention, the low threshold rate is set a level where the utilization rate of the system interface 450 is at 10% of its full utilization rate.

In another embodiment of the invention, the L2 cache memory controller 442 evicts one or more cache memory lines of the L2 cache memory 440 when a timer between each periodic clock interrupt of an operating system (OS) has expired. The OS is operating using processor core 1 420 and/or processor core 2 430 of the processor 410. The duration of the timer is set based on, but is not limited to, the characteristics of the system, the characteristics of the OS, and the length of each periodic clock interrupt of the OS. For example, on a system that has a 20 millisecond clock interrupt interval of the OS, it is unlikely that the processor cores 420 and/or 430 will transition into a low power processor state when the clock interrupt has just occurred. As such, performing the cache evictions of the L2 cache memory lines can be delayed from the start of each periodic clock interrupt of the OS by the use of a timer. When the timer expires, cache evictions of the L2 cache memory lines are enabled.

In another example, if the system that has a 1 millisecond clock interrupt interval, the duration of the timer can be set to zero so that cache evictions of the L2 cache memory lines are always enabled. By having a configurable timer, the processor 410 can be optimized for its dirtiness and C state entry latency reduction.

FIG. 5 illustrates a block diagram 500 of a processor 510 in accordance with one embodiment of the invention. In processor 510, the cache memories have a different configuration compared to the cache memories in processor 410. The L1 cache memory 522 and L2 cache memory 524 are part of the processor core 1 520. Similarly, the L1 cache memory 532 and L2 cache memory 534 are part of the processor core 2 530. The level 3 (L3) cache memory 540 is shared between the processor cores 510 and 530. The processor 510 is also connected with a system interface 550 to a main memory 240 via the L3 cache memory controller 542. The L3 cache memory controller 542 performs eviction of the modified cache memory lines of the L3 memory 540 to a main memory 240 via the system interface 550. The L3 cache memory controller 542 operates in a similar manner as the L2 cache memory controller 442.

The L1, L2, and L3, cache memories shown in FIGS. 4 and 5 are examples of the possible cache memory configurations in a processor and it is not meant to be limiting. One of ordinary skill in the relevant art will readily appreciate that other configurations of the cache memories in the processor can also be used without affecting the workings of the invention. In addition, there can be more than 2 processor cores or just 1 processor in the processors 410 and 510.

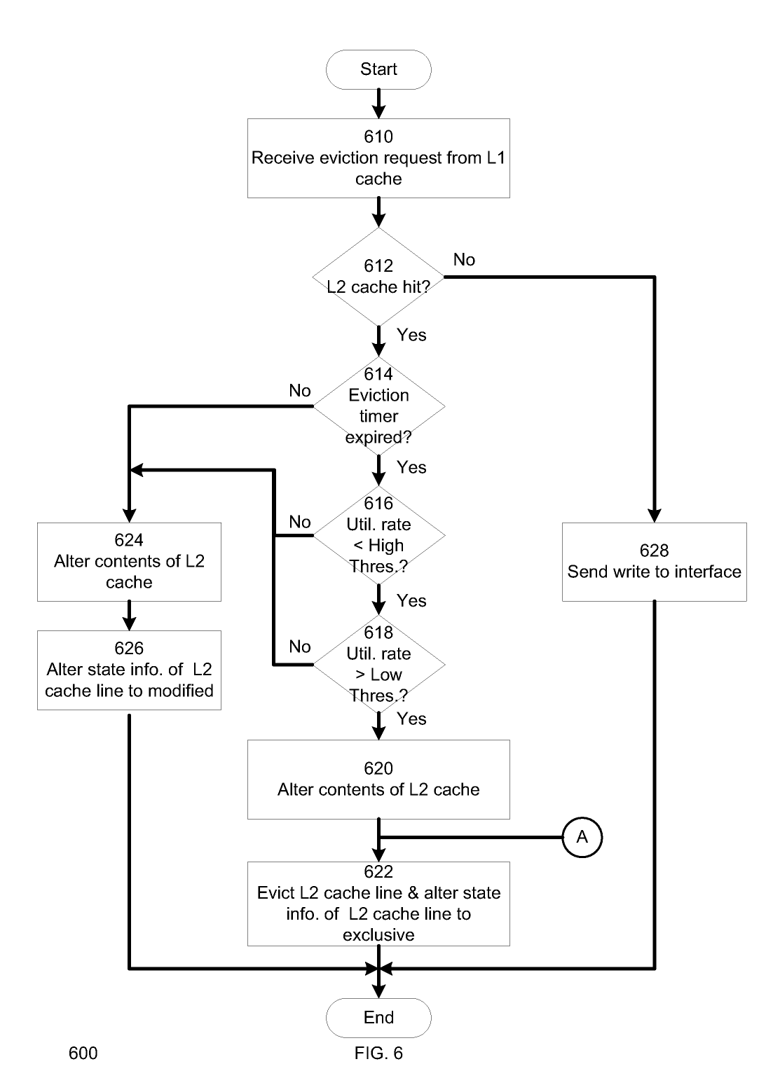

FIG. 6 illustrates a flow chart 600 of the steps to perform background evictions of cache memory lines in accordance with one embodiment of the invention. For the sake of clarity, the steps in flow 600 are discussed with reference to processor 410, processing core 1 420, L1 cache memory 422, L2 cache memory 440 and cache controller 442, and the system interface 450 of FIG. 4. One of ordinary skill in the relevant will readily appreciate that the steps in flow 600 can also be applied to the other embodiments of the cache memories and processing cores described herein.

In step 610, the L2 cache memory controller 442 receives an eviction request of one L1 cache memory line of the L1 cache memory 422. The eviction request can arise from several different scenarios. In one scenario for example, when the processing core 1 420 wants to write to a particular memory address, it determines if the memory address matches one of the L1 cache memory lines. If there is a match, the processing core 1 420 alter the contents of the L1 cache memory line that matches the memory address and may choose to send an eviction request of the one L1 cache memory line to the L2 cache memory controller 442. If there is no match, the processing core 1 420 selects one of the L1 cache memory lines to cache the contents of the particular memory address to be written. If the selected L1 cache memory line has modified contents, the processing core 1 420 sends an eviction request of the selected L1 cache memory line to the L2 cache memory controller 442.

In another scenario for example, when the processing core 1 420 wants to read a particular memory address, it determines if the memory address matches one of the L1 cache memory lines. If there is a match, the processing core 1 420 reads the contents of the matching L1 cache memory line. If there is no match, the processing core 1 420 selects one of the L1 cache memory lines to be replaced with the returned contents of the particular memory address from a higher level cache memory or main memory 240. If the selected L1 cache memory line has modified contents, the processing core 1 420 sends an eviction request of the selected L1 cache memory line to the L2 cache memory controller 442.

In step 612, the L2 cache memory controller 442 determines if the one L1 cache memory line matches any of the L2 cache memory lines. If there is no match, the L2 cache memory controller 442 sends the write request to the main memory 240 or the next higher level of cache memory via system interface 450 in step 628 and the flow 600 ends. If there is a match, the L2 cache memory controller 442 checks if an eviction timer has expired. If the eviction timer has not expired, the L2 cache memory controller 442 alters the contents of the matching L2 cache memory line with the altered contents of the one L1 cache memory line in step 624.

In step 626, the L2 cache memory controller 442 alters the state information associated with the matching L2 cache memory line to a modified state and the flow 600 ends. In one embodiment of the invention, the L1 and L2 cache memories 422 and 440 are operable in accordance with the MESI protocol and each cache memory line of the cache memories 422 and 440 are marked or associated with one of four states: modified, exclusive, shared and invalid. In other embodiments of the invention, the L1 and L2 cache memories 422 and 440 are also operable in accordance with other cache coherency and memory protocols.

If the eviction timer has expired in step 614, the L2 cache memory controller 442 checks if the utilization rate of the system interface 450 is below a high threshold. If no, the flow 600 goes to step 624. If yes, the flow 600 goes to step 618 to check if the utilization rate of the system interface 450 is above a low threshold. If no, the flow 600 goes to step 624. If yes, the flow 600 goes to step 620. In step 620, the L2 cache memory controller 442 alters the contents of the matching L2 cache memory line with the altered contents of the one L1 cache memory line. In step 622, the L2 cache memory controller 442 evicts the matching L2 cache memory line by sending a write request to the main memory 240 or to the next higher level of cache memory via system interface 450 and alters the state information associated with the matching L2 cache memory line to exclusive if the state information associated with the matching L2 cache memory line is not exclusive and the flow ends.

The flow 600 allows the L2 cache memory controller 442 to perform evictions of L2 cache memory lines that have been modified based on the expiry of the eviction timer and the utilization rate of the system interface 450 is between the high and the low threshold. The processor 410 uses an L1 cache memory eviction request to initiate the evictions of L2 cache memory lines that have been modified. By doing so, minimal logic is required to implement embodiments of the invention as the logic for L1 and L2 cache memory eviction request exist. Furthermore, by perform background evictions of L2 cache memory lines during periods of low bus activity, the performance of the processor 410 is improved as bus contention is reduced and there are lesser bus write back queues.

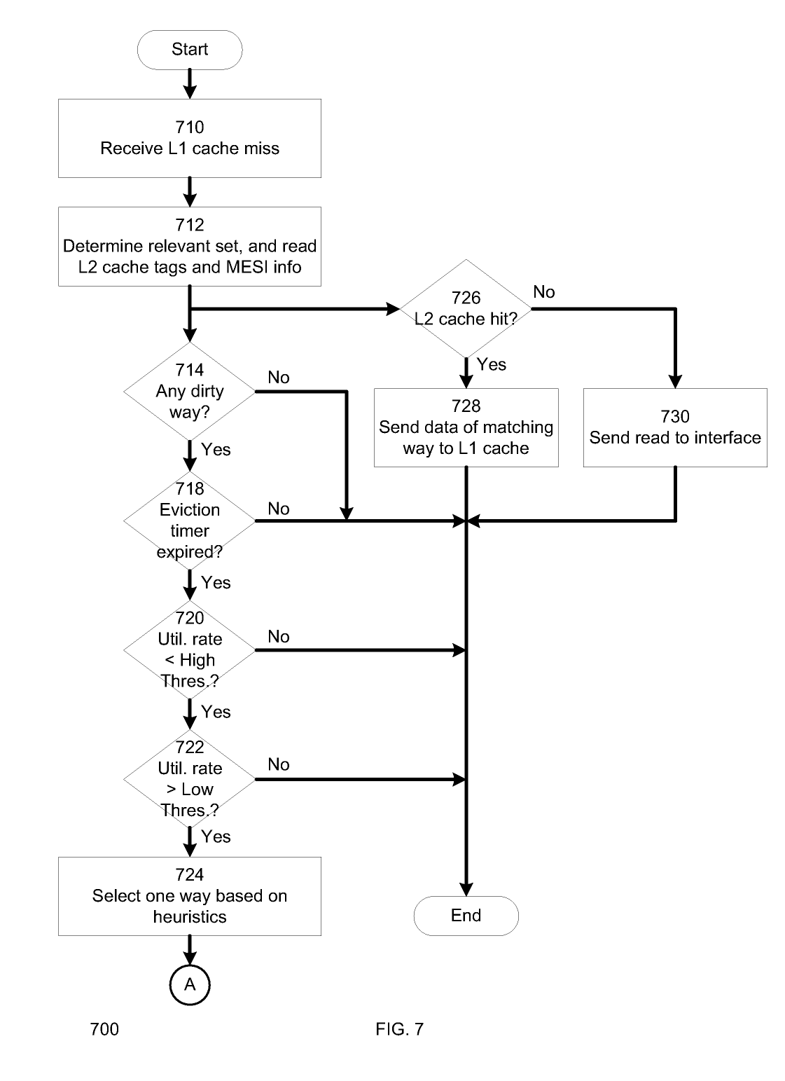

FIG. 7 illustrates a flow chart 700 of the steps to perform background eviction of cache memory lines in accordance with one embodiment of the invention. For the sake of clarity, the steps in flow 700 are discussed with reference to processor 410, processing core 1 420, L1 cache memory 422, L2 cache memory 440 and L2 cache memory controller 442, and the system interface 450 of FIG. 4. One of ordinary skill in the relevant will readily appreciate that the steps in flow 700 can also be applied to the other embodiments of the cache memories and processing cores described herein.

In step 710, the L2 cache memory controller 442 receives a cache memory miss of one cache memory line of the L1 cache memory 422. For example, when the processing core 1 420 wants to read the contents of a particular memory address, it determines if the memory address matches one of the L1 cache memory lines. If there is no match, the processing core 1 420 sends a cache memory miss of the one L1 cache memory line to the L2 cache memory controller 442.

In step 712, the L2 cache memory controller 442 determines the relevant set of the L2 cache memory 440 that has an associated memory range where the particular memory lies in. For example, in one embodiment of the invention, the L2 cache memory 440 is an N-way set associative cache memory. The N-way set associative cache memory groups the L2 cache memory lines into a number of sets and each set of the L2 cache memory 440 has an equal number of cache memory lines. The main memory 240 is also divided into the same number of sets as the L2 cache memory 440. The memory range of the groups in the main memory 240 is associated with a respective set of the L2 cache memory 440. The relevant set of the L2 cache memory 440 is determined by checking which set of the L2 cache memory 440 is associated with the memory range that the particular address lies in.

When the relevant set of the L2 cache memory 440 is determined, all the tag memory of each of the cache memory lines in the relevant set of the L2 cache memory 440 is read. The tag memory indicates the address of the memory location in the main memory 240 that is stored in the L2 cache memory 440. Step 712 also obtains the state information of each cache memory line in the relevant set. In step 726, the L2 cache memory controller 442 checks if the particular address matches any of the tag memories that are read. If there is a L2 cache memory hit, the contents of the matching cache memory line of the L2 cache memory 440 is sent to the L1 cache memory 422 and the flow 700 ends. If there is no cache hit, the L2 cache memory controller 442 sends a read request to the system interface 450 to retrieve the contents of the particular memory address from the memory 240 and the flow 700 ends.

In step 714, the L2 cache memory controller 442 checks if there are any cache memory lines or ways in the relevant set that has a state information of modified. If no, the flow 700 ends. If yes, the L2 cache memory controller 442 checks if the eviction timer has expired in step 718. If no, the flow 700 ends. If yes, the flow 700 goes to step 720 to check if the utilization rate of the system interface 450 is below a high threshold. If no, the flow 700 ends. If yes, the flow 700 checks if the utilization rate of the system interface 450 is above a low threshold. If no, the flow 700 ends. If yes, the flow 700 selects one or more of the modified L2 cache memory lines or ways of the relevant set based on heuristics. The heuristics include but are not limited to, the first, the last, and the least recently used, cache memory line in the relevant set (if any).

After step 724, the flow 700 goes to step 622 to insert an L2 eviction request of the selected one or more L2 cache memory line. The cache memory controller 442 sends the contents of the selected one or more L2 cache memory line to the main memory 240 via the system interface 450 and alters the state information associated with the selected one or more L2 cache memory line to exclusive.

Although the flows 600 and 700 show that the eviction timer check and the threshold check are performed sequentially, this is not meant to be limiting. In other embodiments of the invention, the eviction timer check and the threshold check can be performed in a different order or in parallel. In addition, some of the checks may be omitted in other embodiments of the invention.

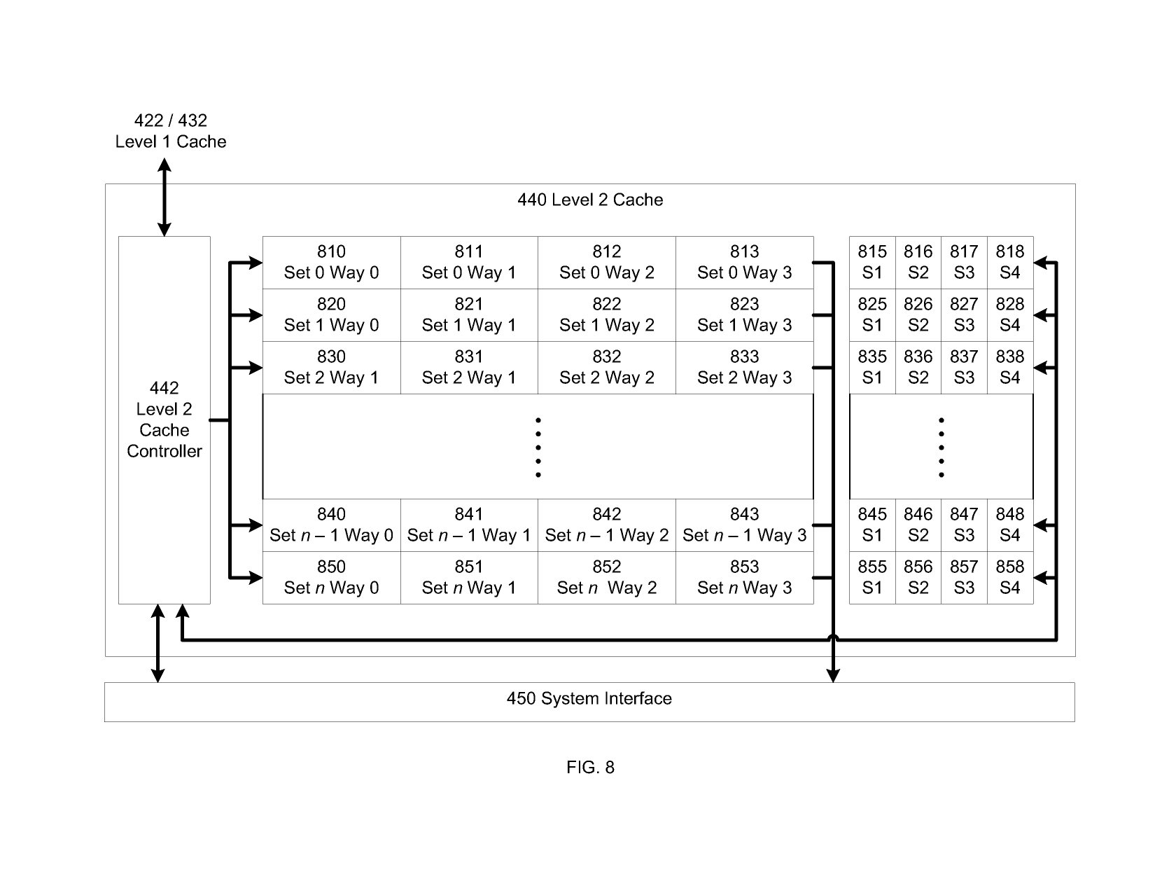

FIG. 8 illustrates a block diagram 800 of a cache memory in accordance with one embodiment of the invention. The block diagram 800 shows one embodiment of the L2 cache memory 440. The L2 cache memory controller 442 of the L2 cache memory 440 is connected to n sets of cache memory lines. Each set of the cache memory lines is divided into 4 ways and each way of each set of the cache memory lines has respective MESI state bits. For example, set 0 has 4 ways: way 0 810, way 1 811, way 2 812, and way 3 813. The ways 810, 811, 812, and 813 have MESI state bits S1 815, S2 816, S3 817, and S4 818 respectively that represent the state of the data in each way.

As an illustration, the steps of the flow 600 are discussed with reference to FIG. 8 to show the workings of the L2 cache memory 440 in one embodiment of the invention. In step 610, the L2 cache memory controller 442 receives an eviction request of one L1 cache memory line of the L1 cache memory 422. In step 612, the L2 cache memory controller 442 determines if the one L1 cache memory line matches any set of the L2 cache memory lines. For the purposes of illustration, the L2 cache memory controller 442 is assumed to find a match of the one L1 cache memory line with set 2 way 3 833 of the L2 cache memory 440. It is further assumed that the eviction timer is determined to have expired in step 614 and the utilization rate of the system interface 450 is determined to be below the high threshold in step 616 and above a low threshold in step 618.

In step 620, the L2 cache memory controller 442 alters the contents of set 2 way 3 833 of the L2 cache memory 44 with the altered contents of the one L1 cache memory line. In step 622, the L2 cache memory controller 442 evicts set 2 by sending a write request to the main memory 240 or to the next higher level of cache memory via system interface 450 and alters the MESI state bits S4 838 to a state of exclusive if the MESI state bits S4 838 are not exclusive.

As another illustration, the steps of the flow 700 are discussed with reference to FIG. 8 to show the workings of the L2 cache memory 440 in one embodiment of the invention. In step 710, the L2 cache memory controller 442 receives a cache memory miss of one cache memory line of the L1 cache memory 422. In step 712, the L2 cache memory controller 442 determines the relevant set of the L2 cache memory 440 that has an associated memory range in which the memory address to be read lies.

For the purposes of illustration, it is assumed that the L2 cache memory controller 442 has determined that set 1 of L2 cache memory 440 has an associated memory range in which the memory address to be read lies. In step 712, the L2 cache memory controller 442 reads the tag memory (not shown in FIG. 8) of way 0 820, way 1 821, way 2 822, and way 3 823 and the MESI state bits S1 825, S2 826, S3 827, and S4 828. In step 714, the L2 cache memory controller 442 checks whether any of the MESI state bits S1 825, S2 826, S3 827, and S4 828 has a state information of modified.

For the purposes of illustration, it is assumed that the tag memory of set 1 way 1 821 has shown that there is a L2 cache memory hit and the MESI state bits S3 827, and S4 828 bits have a state information of modified. It is further assumed that the eviction timer is determined to have expired in step 718 and the utilization rate of the system interface 450 is determined to be below the high threshold in step 720 and above a low threshold in step 722.

In step 724, the L2 cache memory controller 442 can select set 1 way 2 822 or set 1 way 3 823, or both set 1 way 2 822 and set 1 way 3 823, based on heuristics. For the purposes of illustration, it is assumed that the L2 cache memory controller 442 has selected set 1 way 2 822. The flow 700 goes to step 622 to insert an L2 eviction request of set 1 of the L2 cache memory 440. The cache memory controller 442 sends the contents of set 1 of the L2 cache memory 440 to the main memory 240 via the system interface 450 and alters the MESI state bits S3 827 to exclusive.

Embodiments of the invention disclosed herein allow a processor to quickly enter a low power state fast and in response, increase the power savings of the system. In addition, performing background evictions of cache memory lines allow cache memory lines with correctable errors (such as a single bit error) to be corrected by error correcting code (ECC) logic during the eviction before writing it back to memory 240. When an error is detected in a particular cache memory line, the state information of the particular cache memory line is changed from modified to invalid. In this way, it provides additional data protection against non-recoverable errors.

Although examples of the embodiments of the disclosed subject matter are described, one of ordinary skill in the relevant art will readily appreciate that many other methods of implementing the disclosed subject matter may alternatively be used. In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

The term “is operable” used herein means that the device, system, protocol etc, is able to operate or is adapted to operate for its desired functionality when the device or system is in off-powered state. Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

The techniques shown in the figures can be implemented using code and data stored and executed on one or more computing devices such as general purpose computers or computing devices. Such computing devices store and communicate (internally and with other computing devices over a network) code and data using machine-readable media, such as machine readable storage media (e.g., magnetic disks; optical disks; random access memory; read only memory; flash memory devices; phase-change memory) and machine readable communication media (e.g., electrical, optical, acoustical or other form of propagated signals—such as carrier waves, infrared signals, digital signals, etc.).

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. An apparatus comprising:
a cache memory having a plurality of cache memory lines; and
a cache memory controller coupled with the cache memory and an interface, wherein the cache memory controller is to evict one of the plurality of cache memory lines when a utilization rate of the interface is between a low and a high threshold.

2. The apparatus of claim 1, wherein the cache memory controller to evict the one cache memory line when the utilization rate of the interface is between the low and the high threshold is to evict the one cache memory line when the utilization rate of the interface is between the low and the high threshold and when a timer between each periodic clock interrupt of an operating system (OS) has expired, wherein the OS is to operate using the apparatus.

3. The apparatus of claim 1, wherein the cache memory is an upper level cache memory, wherein each cache memory line is an upper level cache memory line and wherein the apparatus further comprises:
one or more lower level cache memories coupled with the upper level cache memory, each lower level cache memory having a plurality of lower level cache memory lines; and
one or more logic units coupled to a respective one of the one or more lower level cache memories, each logic unit to access contents of a memory address.

4. The apparatus of claim 3, wherein each logic unit of the apparatus to access the contents of the memory address is to:
determine if the memory address matches one of the plurality of lower level cache memory lines; and
if so,
alter contents of the one lower level cache memory line; and
send optionally an eviction request of the one lower level cache memory line to the cache memory controller; and
if not,
select one of the plurality of lower level cache memory lines to be replaced with contents of the memory address from a higher level cache memory or a main memory; and
send the eviction request of the one lower level cache memory line to the cache memory controller if the one lower level cache memory line has an associated state information of modified.

5. The apparatus of claim 4, wherein the cache memory controller is further to:
receive the eviction request; and
determine that the one upper level cache memory line matches the one lower level cache memory line, wherein evicting the one upper level cache memory line is to:
alter the contents of the one upper level cache memory line with the altered contents of the one lower level cache memory line;
evict contents of the one upper level cache memory line; and
alter state information associated with the one upper level cache memory line to exclusive if the state information associated with the one upper level cache memory line is not exclusive.

6. The apparatus of claim 3, wherein each logic unit of the apparatus to access the contents of the memory address is to:
determine that the memory address does not match any lower level cache memory line; and
send a lower level cache memory miss request to the cache memory controller.

7. The apparatus of claim 6, wherein the plurality of the upper level cache memory lines are grouped into a plurality of sets of the upper level cache memory lines, each set comprising an equal number of upper level cache memory lines, and wherein the cache memory controller is further to:
determine a set of the plurality of sets, wherein the memory address is within a memory range associated with the set;
obtain state information associated with each upper level cache memory line of the determined set;
determine that at least one upper level cache memory line of the determined set has an associated state information of modified; and
select one or more of the at least one upper level cache memory line of the determined set based on heuristics, wherein evicting the one upper level cache memory line is to evict the selected one or more of the at least one upper level cache memory line of the determined set.

8. The apparatus of claim 7, wherein the cache memory controller to evict the one upper level cache memory line is further to alter the state information associated with the selected one or more of the at least one upper level cache memory line of the determined set to exclusive.

9. The apparatus of claim 3, wherein the lower level cache memory is a level one cache memory, and wherein the upper level cache memory is one of a level two, and level three, cache memory.

10. A system comprising:
a memory unit having a plurality of memory lines to store data; and
a processor coupled with the memory unit via a bus, the processor comprising:
a cache memory having a plurality of cache memory lines; and
a cache memory controller coupled with the cache memory and the bus,
wherein the cache memory controller is to evict one of the plurality of cache memory lines when a timer between each periodic clock interrupt of an operating system (OS) has expired, the OS to operate using the processor.

11. The system of claim 10, wherein the cache memory controller of the processor to evict the one cache memory line when the timer between each periodic clock interrupt of the OS has expired is to evict the one cache memory line when the timer between each periodic clock interrupt of the OS has expired and when a utilization rate of the bus is between the low and the high threshold.

12. The system of claim 10, wherein a duration of the timer is set based on one of characteristics of the system, characteristics of the OS, and length of each periodic clock interrupt of the OS.

13. The system of claim 11, wherein the low and the high thresholds are determined such that evicting the one cache memory line has minimal performance cost to the system.

14. The system of claim 10, wherein the cache memory of the processor is an upper level cache memory, wherein each cache memory line is an upper level cache memory line and wherein the processor further comprises:
one or more lower level cache memories coupled with the upper level cache memory, each lower level cache memory having a plurality of lower level cache memory lines; and
one or more processor cores coupled to a respective one of the one or more lower level cache memories, each processor core to access contents of a memory address.

15. The system of claim 14, wherein each processor core of the processor to access the contents of the memory address is to:
determine if the memory address matches one of the plurality of lower level cache memory lines; and
if so,
alter contents of the one lower level cache memory line; and
send optionally an eviction request of the one lower level cache memory line to the cache memory controller; and
if not,
select one of the plurality of lower level cache memory lines to be replaced with contents of the memory address from a higher level cache memory or a main memory; and
send the eviction request of the one lower level cache memory line to the cache memory controller if the one lower level cache memory line has an associated state information of modified.

16. The system of claim 15, wherein the cache memory controller of the processor is further to:
receive the eviction request; and
determine that the one upper level cache memory line matches the one lower level cache memory line, wherein evicting the one upper level cache memory line is to:
alter the contents of the one upper level cache memory line with the altered contents of the one lower level cache memory line;
evict contents of the one upper level cache memory line; and
alter state information associated with the one upper level cache memory line to exclusive if the state information associated with the one upper level cache memory line is not exclusive.

17. The system of claim 14, wherein each processor core of the processor to access the contents of the memory address is to:
determine that the memory address does not match any lower level cache memory line; and
send a lower level cache memory miss request to the cache controller.

18. The system of claim 17, wherein the plurality of the upper level cache memory lines are grouped into a plurality of sets of the upper level cache memory lines, each set comprising an equal number of upper level cache memory lines, and wherein the cache memory controller of the processor is further to:
determine a set of the plurality of sets, wherein the memory address is within a memory range associated with the set;
obtain state information associated with each upper level cache memory line of the determined set;
determine that at least one upper level cache memory line of the determined set has an associated state information of modified; and
select one or more of the at least one upper level cache memory line of the determined set based on heuristics, wherein evicting the one upper level cache memory line is to evict the selected one or more of the at least one upper level cache memory line of the determined set.

19. The system of claim 18, wherein the cache memory controller of the processor is further to alter the state information associated with the selected one or more of the at least one upper level cache memory line of the determined set to exclusive.

20. The system of claim 14, wherein the lower level cache memory is a level one cache memory, and wherein the upper level cache memory is one of a level two, and level three, cache memory.

21. A method comprising:
evicting one of a plurality of cache memory lines when a utilization rate of an interface is between a low and a high threshold, wherein the interface is to couple with a cache memory having the plurality of cache memory lines.

22. The method of claim 21, wherein evicting the one cache memory line when the utilization rate of the interface is between the low and the high threshold is evicting the one cache memory line when the utilization rate of the interface is between the low and the high threshold and when a timer between each periodic clock interrupt of an operating system (OS) has expired, wherein the OS is to operate using the apparatus.

23. The method of claim 22, wherein the plurality of cache memory lines is a plurality of upper level cache memory lines, further comprising:
receiving an eviction request of one of a plurality of lower level cache memory lines; and
determining that the one upper level cache memory line matches the one lower level cache memory line; and wherein evicting the one cache memory line comprises:
altering contents of the one upper level cache memory line with contents of the one lower level cache memory line; and
evicting contents of the one upper level cache memory line; and
altering state information associated with the one upper level cache memory line to exclusive if the state information associated with the one upper level cache memory line is not exclusive.

24. The method of claim 22, wherein the plurality of cache memory lines is a plurality of upper level cache memory lines, wherein the plurality of the upper level cache memory lines are grouped into a plurality of sets of the upper level cache memory lines, each set comprising an equal number of upper level cache memory lines, further comprising:
receiving a cache memory miss request of one of a plurality of lower level cache memory lines to access a memory address;
determining a set of the plurality of sets, wherein the memory address to be accessed is within a memory range associated with the set;
determining that at least one upper level cache memory line of the determined set has an associated state information of modified;
selecting one or more of the at least one upper level cache memory line of the determined set based on heuristics, wherein evicting the one upper level cache memory line is evicting the selected one of the at least one upper level cache memory line of the determined set; and
altering the state information associated with the selected one or more of the at least one upper level cache memory line of the determined set to exclusive.
